(19) United States
(12) Patent Application Publication
(10) Pub. No.: US 2021/0234666 A1
(43) Pub. Date: Jul. 29, 2021

(54) ENHANCED BLOCKCHAIN MASTER NODE COMPUTING STACK

(71) Applicant: Project Verte Inc., New York, NY (US)

(72) Inventors: Shlomi Amouyal, New York, NY (US); Ofir Hackmon, New York, NY (US)

(21) Appl. No.: 17/159,988

(22) Filed: Jan. 27, 2021

Related U.S. Application Data
(60) Provisional application No. 62/966,211, filed on Jan. 27, 2020.

(51) Int. Cl. H04L 9/06; G06F 9/54

(52) U.S. Cl. CPC H04L 9/0618; G06F 9/547; H04L 9/0643

(57) ABSTRACT

A multi-layer software stack for supporting blockchain transactions includes a wrapper layer, an entities logic layer, a dynamic structure layer, and a blockchain layer. The wrapper layer provides blockchain nodes with access to transaction data stored on the blockchain. This wrapper layer includes a public application programming interface (API) that provides functions for accessing public transaction data stored on the blockchain, and a private API that provides functions for accessing private transaction data stored on the blockchain. The entities logic layer includes an encryption component that provides encryption algorithms for encrypting and decrypting the private transaction data. The dynamic structure layer comprises a field-level encryption component that provides additional encryption algorithms for encrypting and decrypting individual fields of the transaction data. The blockchain layer includes blocks storing the transaction data in the blockchain. Encryption and compression methods are provided for blockchains using the stack.

### CROSS REFERENCE TO RELATED APPLICATIONS

This application claims the benefit of priority of U.S. Provisional Patent Application Ser. No. 62/966,211, filed on Jan. 27, 2020, which is incorporated herein by reference in its entirety.

### TECHNICAL FIELD

The present disclosure relates generally to an enhanced blockchain master node computing stack supporting high-volume, high-throughput, secure transaction processing. The blockchain described herein may be utilized, for example, in the context of supply chain management for storing data related to purchases made with one or more retailers.

### BACKGROUND

A blockchain is a network of computers (or “nodes”) that stores transaction data in a ledger distributed/over the computers. Blocks are used to store information about transactions. For example, in the context of a supply chain management blockchain, blocks may store information such as the date and time that certain purchases occurred, as well as the dollar amount of the items purchased. In many blockchain implementations, the blocks also store the information about who is participating in the transaction (e.g., the purchaser of a product). Each block stores a unique hash that distinguishes it from other blocks on the chain.

Conventional blockchain implementations have several significant drawbacks. First, conventional implementations provide either public or private access to transaction data. A public blockchain is publicly readable and any party can make changes or edit a block in chain. Conversely, a private blockchain may impose requirements such as what parties have permission to read, transact, and edit data on the blockchain. There is currently no mechanism for providing a mix of public and private access to the blockchain. Another major limitation of conventional implementations of blockchain is that it typically takes much more time to execute a transaction on a blockchain compared to other data storage systems. Currently, it takes on the order of 10 minutes for a block to be generated before it can be used to store transaction data. With the block, the transaction cannot be verified by the blockchain. Thus, block's ability to process a transaction is directly limited by the block generation time.

### SUMMARY

Embodiments of the present invention address and overcome one or more of the above shortcomings and drawbacks by providing methods, systems, and apparatuses related to an enhanced blockchain master node computing stack supporting high-volume, high-throughput secure transaction processing.

According to some embodiments, a multi-layer software stack for supporting blockchain transactions includes a wrapper layer, an entities logic layer, a dynamic structure layer, and a blockchain layer. The wrapper layer provides blockchain nodes with access to transaction data stored on the blockchain. This wrapper layer includes a public application programming interface (API) that provides functions for accessing public transaction data stored on the blockchain, and a private API that provides functions for accessing private transaction data stored on the blockchain. The entities logic layer includes an encryption component that provides encryption algorithms for encrypting and decrypting the private transaction data. The dynamic structure layer comprises a field-level encryption component that provides additional encryption algorithms for encrypting and decrypting individual fields of the transaction data. The blockchain layer includes blocks storing the transaction data in the blockchain.

According to some embodiments, a method for encrypting an input blockchain data structure that contains a plurality of data blocks is provided. A processor obtaining a first secret key having a static initial state and a random session key that is created for each blockchain being encrypted. The system creates a dynamic object key that is a function of the second secret key and the random session key. This session key can be seeded by user input, in some embodiments. For each data block, the system changes the dynamic object key based on the random session key and encrypts the data block using the dynamic object key to create an encrypted file of the blockchain that contains ciphertext of each data block. The system adds a hash of the data blocks to the encrypted file using a keyed hash function that utilizes a second secret key seeded by data blocks of the input blockchain the to create a digital signature. The digital signature object key can be seeded by user input. The encrypted file is then transmitted to a blockchain network. The first secret key can be at least 4096 bits and the second secret key can be 2048 bits, resulting in a 2048 bit signature.

According to some embodiments, a method for compressing a blockchain (having a plurality of data strings) for transmission over a blockchain network is provided by the software system. For each data string, the system replaces one of more input data characters with new characters to create a current data string and matches the current data string to the contents of a longest previous data string. The system places a code corresponding to the longest previous data string into a compressed data stream and attempts to extend current data string by a plurality of symbols. If the string can be extended, the system places a string extension length indicative of the plurality of symbols into the compressed data stream. The compressed data stream is then encrypted and transmitted to the blockchain/decentralized network.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawing embodiments that are presently preferred, it being understood, however, that the invention is not limited to the specific instrumentalities disclosed. Included in the drawings are the following Figures:

FIG. 1 shows a multi-layer software stack for supporting blockchain transactions, according to some embodiments;

FIG. 2 illustrates an example Memory Pool that can be used in some embodiments;

FIG. 3 shows an example of how the DPL Component can be implemented, according to some embodiments;

FIG. 4 provides examples of how data is compressed for transmission over a blockchain network, according to the some embodiments of the present invention;

FIG. 5A shows how compression may be performed by chaining 4 compressors in sequence, according to some embodiments;

FIG. 5B shows the Method 1 Compressor in detail;

FIG. 5C shows the Method 2 Compressor;

FIG. 5D shows the Method 3 Compressor;

FIG. 5E shows the Method 4 Compressor;

FIG. 6 shows an example data classing structure that can be used to support the data compression technique described herein;

FIG. 7 shows an example data structure that may be used in some embodiments;

FIG. 8 shows code for an example data decoder that may be used in some embodiments;

FIG. 9A provides an overview of the general architecture, which utilizes static keys and dynamic keys according to some embodiments;

FIG. 9B provides a high-level overview of the encryption process, as it may be implemented in some embodiments;

FIGS. 9C-9L describes the encryption process in more detail;

FIGS. 10A and 10B show an example output line resulting from the encryption process;

FIGS. 10C and 10D show example code that may be used during seed and key generation, according to some embodiments;

FIG. 10E shows how the seeds are utilized in the encryption process described above.

FIG. 11 shows an example use case in the context of supply chain management; and

FIG. 12 illustrates an exemplary computing environment within which embodiments of the invention may be implemented.

### DETAILED DESCRIPTION

The following disclosure describes the present invention according to several embodiments directed at methods, systems, and apparatuses related to an enhanced blockchain master node computing stack. As is generally understood in the art, a master node is a computing device in the blockchain network that performs operations such as validating, saving, and broadcasting transactions as well as administrative events (e.g., governing voting, executing protocol operations, and enforcing the rules of the blockchain). Master nodes typically include more processing and storage capability than other nodes in the blockchain network. The techniques disclosed herein utilize a multi-layer software stack where each layer comprises software components that work in tandem to execute specific master node tasks.

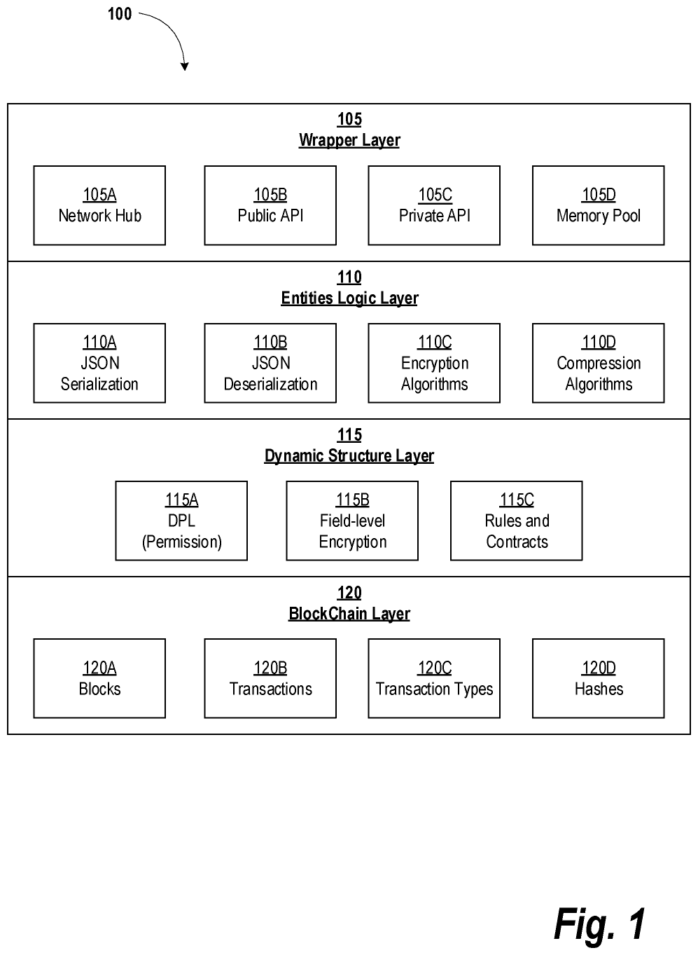

FIG. 1 shows a multi-layer software stack for supporting blockchain transactions, according to some embodiments. The Wrapper Layer 105 is a networking layer. The Network Hub 105A is a peer-to-peer mechanism that handles communication tasks between nodes of the blockchain including, without limitation, managing the DNS server that assists in peer discovery (i.e., the DNS seed) and new member registration to the peer network.

Conventional blockchain solutions typically operate in either a public or a private manner. That is, the structure of conventional blockchain solutions does not provide the flexibility to support both public and private data on the same blockchain. This limits the applicable use cases. To address this deficiency of conventional solutions, the Multilayer Stack 100 shown in FIG. 1 includes a Public API 105B as well as a Private API 105C. The Public API 105B includes one or more functions implemented in the HTTP protocol for receiving read and write request from the global network, and routing communications to various components in the Stack 100. The Private API 105C comprises one or more functions implementing a HTTPs protocol for receiving read and write request form the private and internal systems, and for routing the communications to the private data layer in the Stack 100. In some embodiments, the Private API 105C is limited to encrypted data only. The Private API 105C may utilize private keys or other security features generally known in the art to limit use of API functions to specific entities.

The Wrapper Layer 105 also includes a Memory Pool 105D. This Memory Pool 105D is a dynamic memory component capable of dividing large amounts of data and functions into blocks to process applications quickly and systematically while managing a full memory array. By providing the Memory Pool 105D in the Wrapper Layer 105, the Stack 100 increases the number of transactions that can be performed within a given time period in the Wrapper Layer 105, in comparison to conventional blockchain solutions. For example, conventional blockchains often restrict the size of transactions to allow timing goals to be met. Even then, a conventional block chain may still require a relatively long period of time to confirm a transaction (e.g., on the order of seconds). The Memory Pool 105D provides the ability to act as a “cache,” providing quick access to data without requiring transactions to be arbitrarily small to address timing concerns. Moreover, by providing memory directly at the Wrapper Layer 105, the Stack 100 is capable of acting as a data buffer; thus, the Stack 100 can provide high-volume, high-throughput transaction processing without any reliance on the memory provided at the Blockchain Layer 120, which is limited by design.

The Entities Logic Layer 110 comprises JavaScript Object Notion (JSON) Serialization 110A and JSON Deserialization 110B components. As is generally understood in the art, JSON is a data format that encodes objects into strings to facilitate transmission over standard network data protocols. The term “serialization” refers to the encoding an object into a string, while the term “deserialization” refers to decoding an object from a string. By using JSON, complex objects can be sent using these protocols. It should be noted that that the use of JSON is merely exemplary. The modular nature of the JSON Serialization 110A and JSON Deserialization 110B components allows alternative or additional data-interchange formats to be supported by the Stack 100 such as YAML, BSON, and MessagePack. In one embodiment, data is stored using a .NET Core 2.2 object using a class such as JsonSerializer. To convert .NET objects to their JSON equivalent and back again, the .NET object property names are mapped to JSON properties names.

The Entities Logic Layer 110 further comprises an Encryption Component 110C that encrypts and decrypts data as it is transferred between the Wrapper Layer 105 and the other layers of the Stack 100. In some embodiments, a customized encryption library is used that employs SHA256 for hashing 32 bit data, SHA512 for hashing 64 bit data and Advanced Encryption Standard (AES) for crypto with Secp256r1.

The Entities Logic Layer 110 also includes Compression Algorithms 110D that compress and decompress indexed data values as they are transferred between the Wrapper Layer 105 and the other layers of the Stack 100.

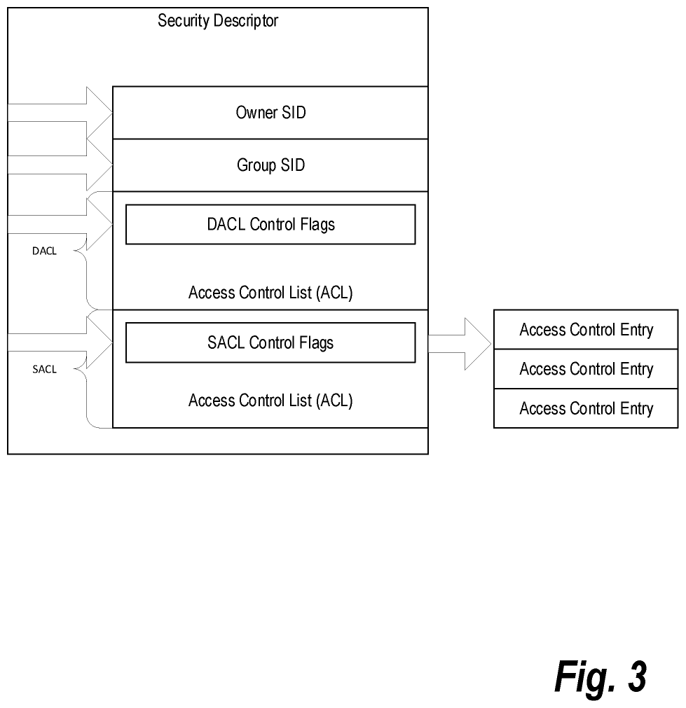

The Dynamic Structure Layer 115 includes a Dynamic Permission Layer (DPL) Component 115A which manages permissions used for performing activities related to sending and receiving transactions. In this example, permissions can be dynamically set, for example, by submitting transactions modifying a special record stored by the Stack 100. For example, by default, a group of users can be granted permission to view but not modify a group of transactions. An administrator can submit a transaction that specifies that a certain user should also be granted write permission. Thereafter, that user will have the ability to modify transaction data stored in the blockchain. Various techniques may be used for dynamically modifying permissions. For example, in one embodiment, a JSON file may be submitted with fields specifying specific permissions and the groups of transaction data to which those permissions apply. Additional details on the DPL Component are described below with reference to FIG. 3.

The Field-level Encryption Component 115B is used to encrypt individual fields of data within a dataset. With this Component 115B, each user who holds the key for an object is able to assign permissions to individual information fields specifying whether the fields will be saved in a public manner (i.e., displayed publicly on the ledger) or in a private manner (i.e., encrypted and only made available to certain privileged users). Thus, this function may be utilized in the context of public blockchains where the data in the blockchain is generally publically viewable; however a subset of the fields is private. For example, in a supply chain context, the tracking number or address may be encrypted and only the parties with the keys can view this data. Field-level encryption may be accessed, for example, by a user when creating an object for storage on the blockchain. For example, in some embodiments, a dashboard interface is provided to the user for creating new objects and the user can specify particular fields where field-level encryption should be applied. The type of encryption applied by the Field-level Encryption Component 115B may be the same general algorithms as applied by the Encryption Algorithms 110C in the Entities Logic Layer, or different encryption algorithms could be applied.

The Rules and Contracts Component 115C provides templates that allows users to implement business rules and contracts that may be automatically applied to objects stored in the blockchain. For example, in the context of a supply chain, a rule may indicate that when a package is delivered to a customer and the delivery service confirms delivery, a charge on the customer's credit card is initiated. As another example, a rule may indicate that upon delivery, a vendor should be paid (minus any expenses).

The Blockchain Layer 120 implements the core of the blockchain. The Blocks 120A, Transactions 120B, and Hashes 120D are used as in conventional blockchain systems. The Transaction Types 120C allows the transaction type to be saved with the transaction. This allows the user to specifically query the blockchain based on transaction type.

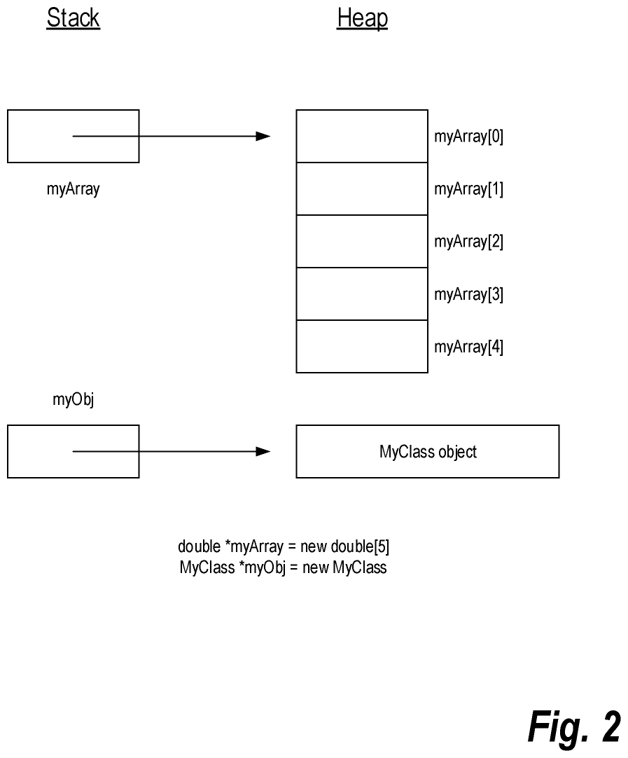

FIG. 2 illustrates an example Memory Pool that can be used in some embodiments. As noted above, the Memory Pool is the component of the blockchain discussed herein that is capable of efficiently processing large amounts of data. FIG. 2 shows conceptually how the Memory Pool is implemented on the memory stack. In one embodiment, this is implemented using flash memory to allow for very fast reading and writing speeds. Data is written to the heap as blocks, and these blocks are entered into the blockchain one by one as resources become available for processing. This “buffering” mechanism facilitates quicker transaction processing times in contrast to conventional blockchain stacks that wait until data is entered into the blockchain itself before verifying that transaction is complete.

FIG. 3 shows an example of how the DPL Component can be implemented, according to some embodiments. In this example, the DPL component enables smart and independent management permissions for each transaction using a Security Descriptor (SD) identified by a Security Identifier (SID). The SD includes two types of Access Control Lists (ACL): a Discretionary Access Control List (DACL) and a System Access Control List (SACL). Each ACL comprises a list of Access Control Entries (ACEs) that identify trustees for objects and specify rights that are granted to that trustee. When a request is made to access an object, the ACEs on the DACL are checked to determine whether the access should be granted. The ACEs in the SACL specify the types of access attempts by a trustee that should be recorded in the security event log. The SACL allows administrators to log attempts to access a secured object.

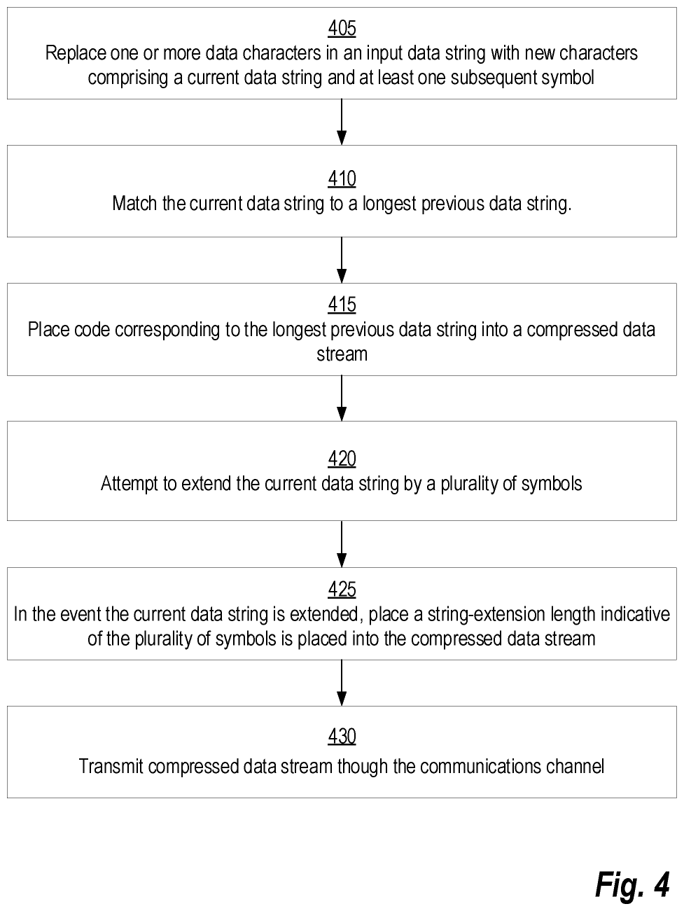

FIG. 4 provides examples of how data is compressed for transmission over a blockchain network, according to the some embodiments of the present invention. Starting at step 405, an input data string is processed to replace one or more data characters comprising a current data string and at least one subsequent symbol. Next, at step 410, the current data string is matched to a longest previous data string. The previous data character is defined by a code. This code is placed into a compressed data stream at step 415. Next, at step 420, the system performing the compression algorithm attempts to extend the current data string by a plurality of symbols. Then, in the event the current data string is extended, a string-extension length indicative of the plurality of symbols is placed into the compressed data stream at step 425. Finally, at step 430, compressed data stream is transmitted though the communications channel.

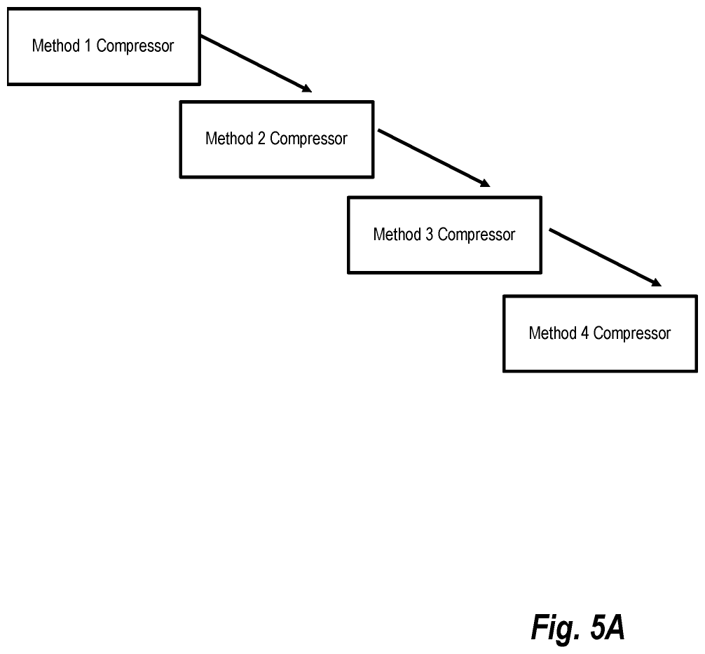

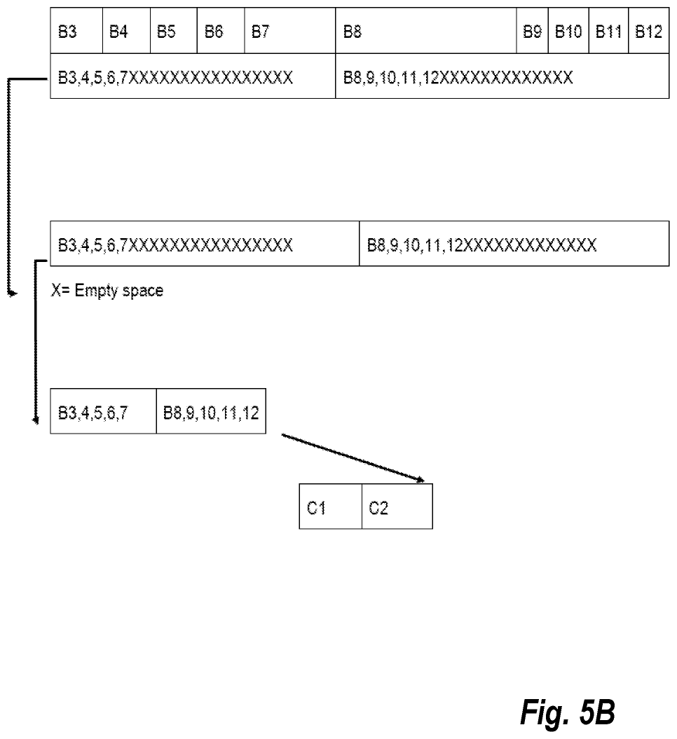

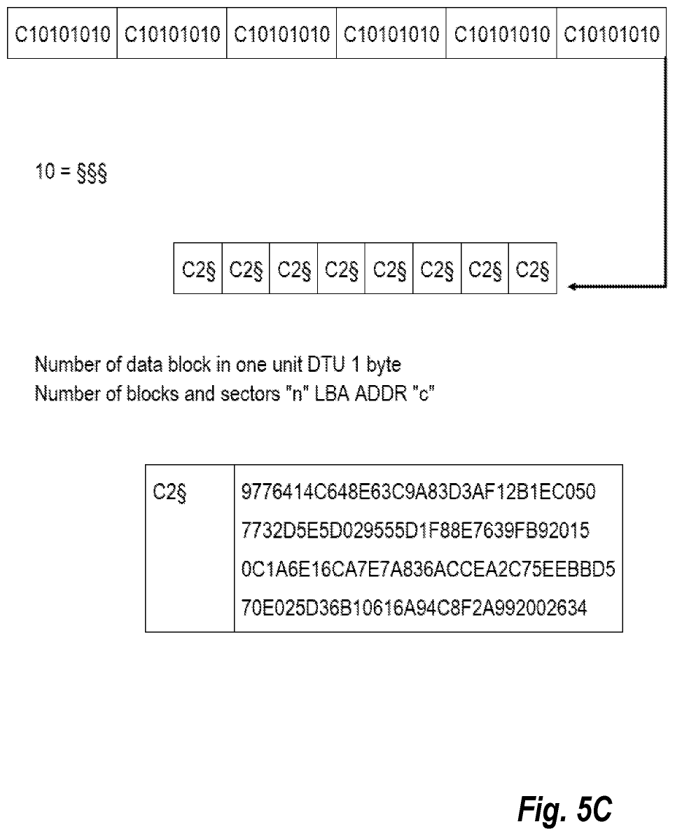

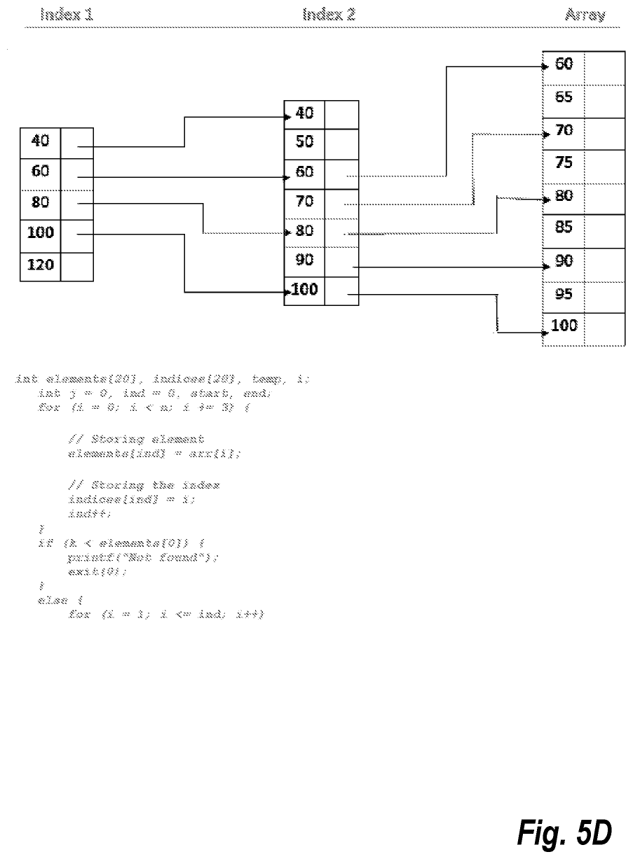

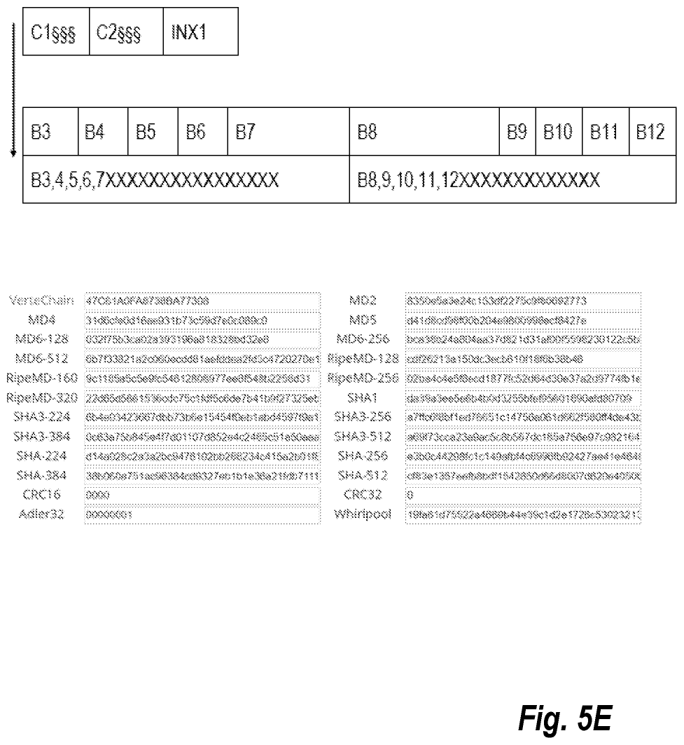

FIGS. 5A-5E provide additional details on how compression can be performed, according to some embodiments. As shown in FIG. 5A, compression is performed by chaining 4 compressors in sequence. These compressors are referred to as the Method 1 Compressor, the Method 2 Compressor, the Method 3 Compressor, and the Method 4 Compressor, respectively.

FIG. 5B shows the Method 1 Compressor in detail. The Method 1 Compressor divides the cells into 10 digit numeric structures with the smallest cell input. The output (“C1” and “C2”) provides small chunks of data with an indexing layer to preserve data consistency.

FIG. 5C shows the Method 2 Compressor. As shown in the figure, the first byte of every cell in the block with symbol (§§§, in this example). The Method 2 Compressor outputs a compressed version of the input data (C2 in this example). In some embodiments, the compression rate is approximately 76%.

FIG. 5D shows the Method 3 Compressor. During this C3 level compressor, the index structure is modified to allow more data to be compressed on the prefix byte of the block.

FIG. 5E shows the Method 4 Compressor. This compressor sets the final structure before streaming the data chunk to the channel to be combined with the blocks. The bottom portion of FIG. 5E shows an example word hash calculation of the data after compression is performed.

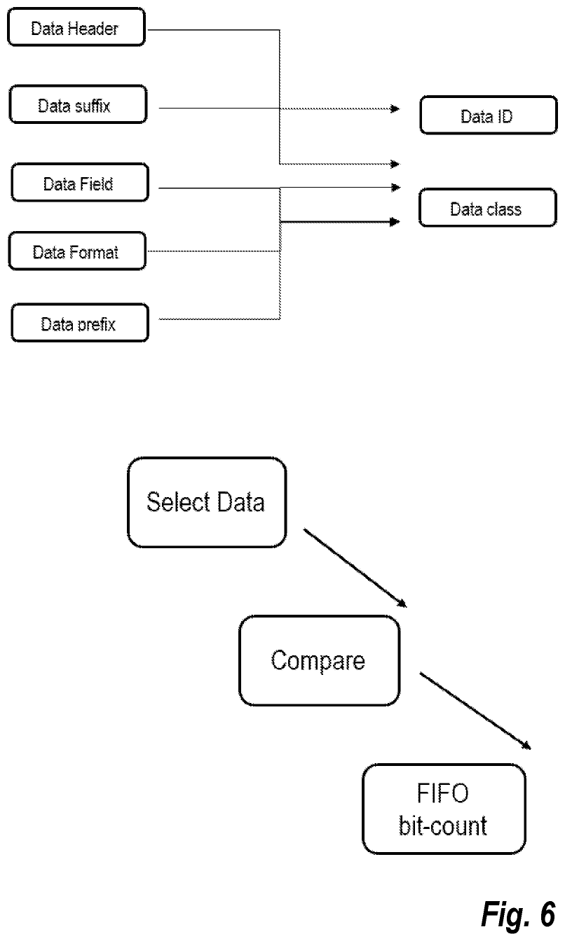

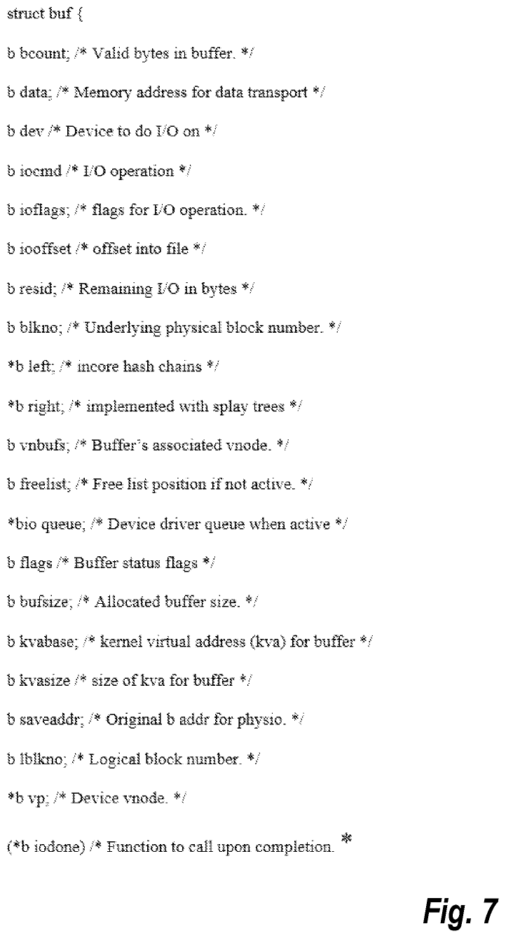

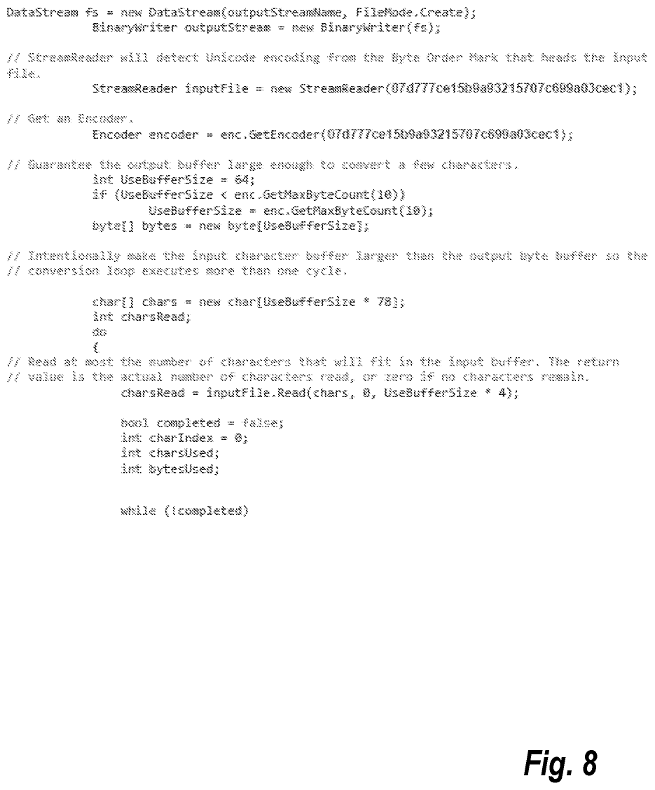

FIG. 6 shows an example data classing structure that can be used to support the data compression technique described herein. When an input or output request is received by the top half of the compression process (see FIG. 4), it is recorded in this a data structure (typically a buf struct) that is added to the I/O queue. FIG. 7 shows an example data structure that may be used in some embodiments. Finally, FIG. 8 shows code for an example data decoder that may be used in some embodiments.

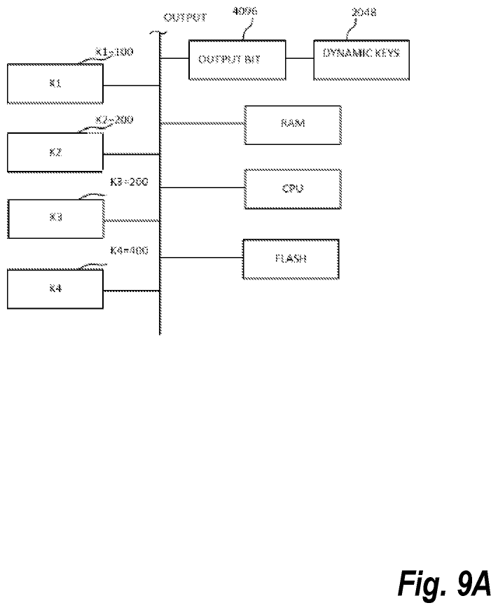

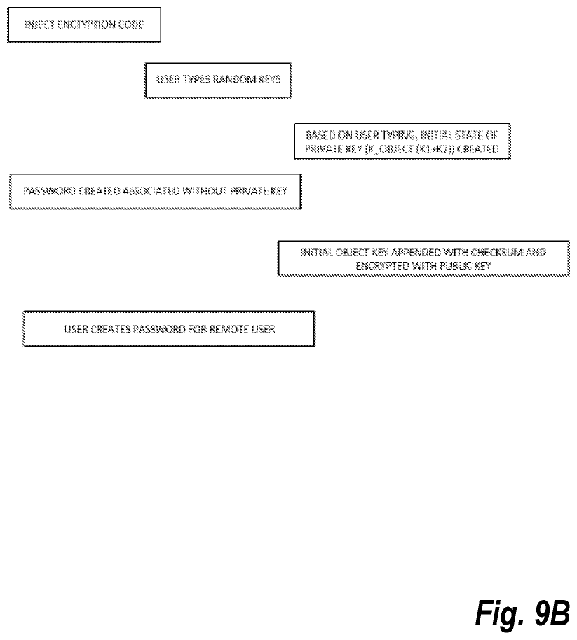

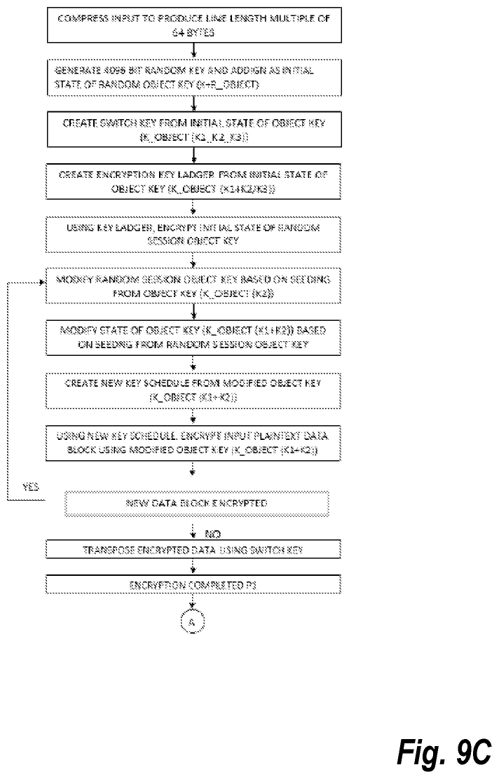

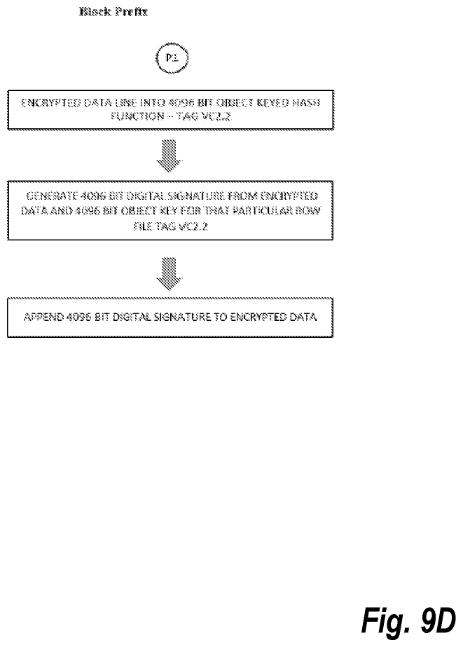

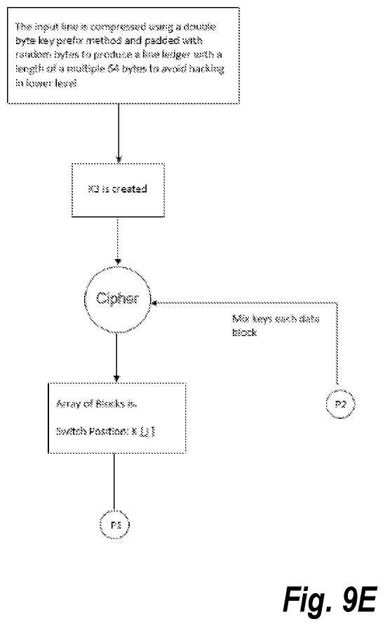

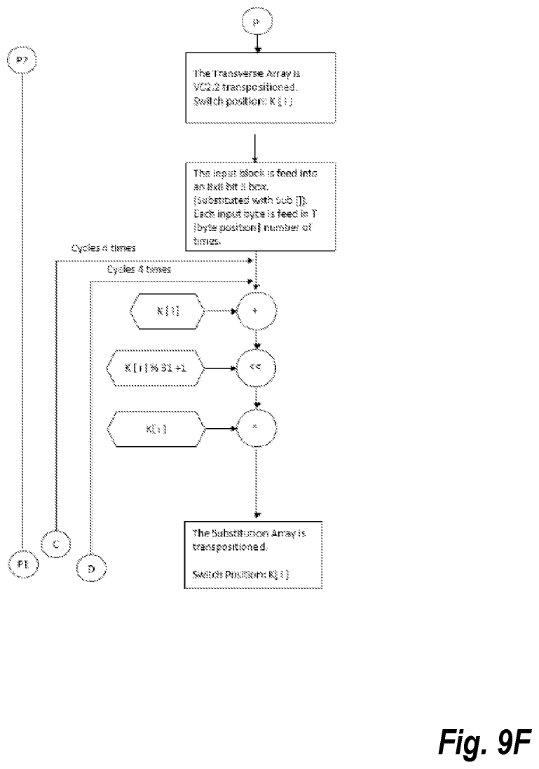

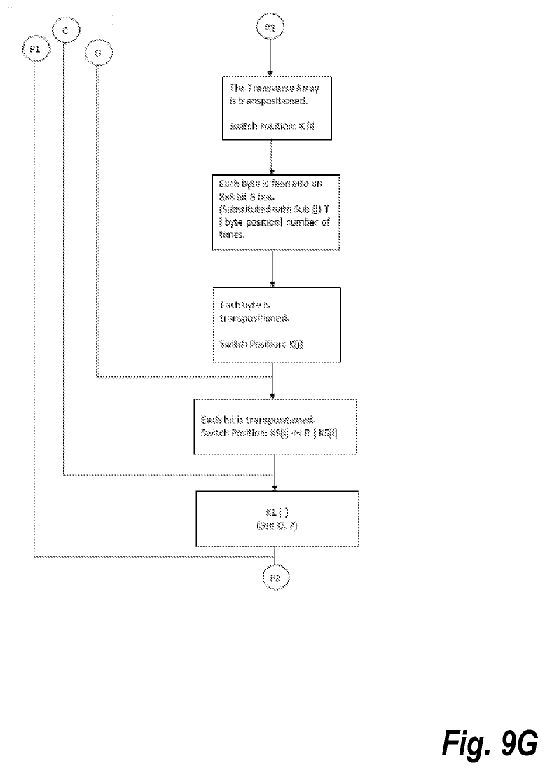

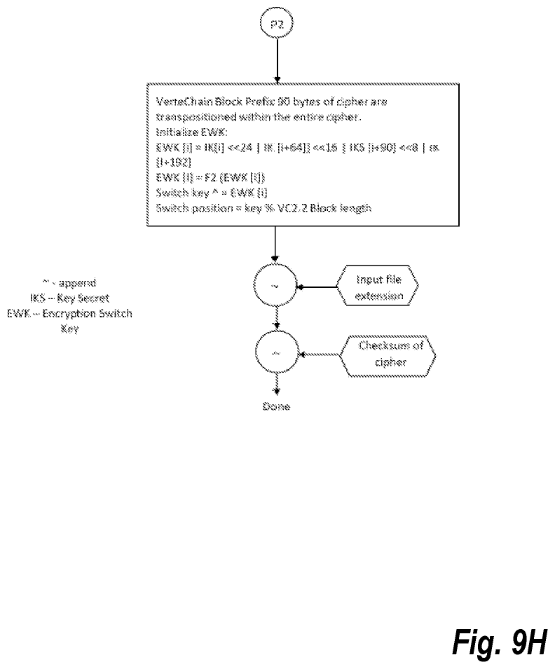

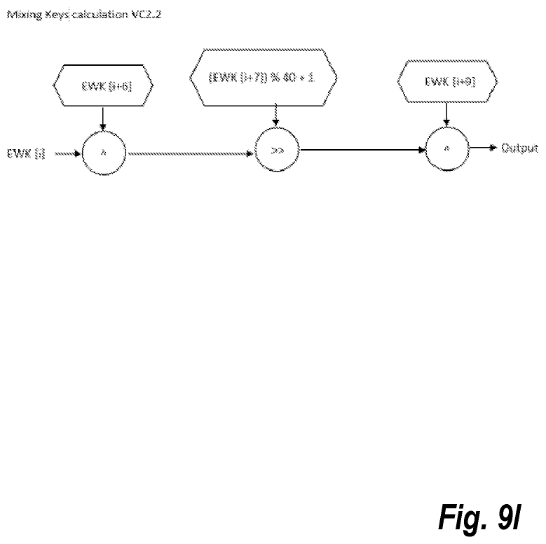

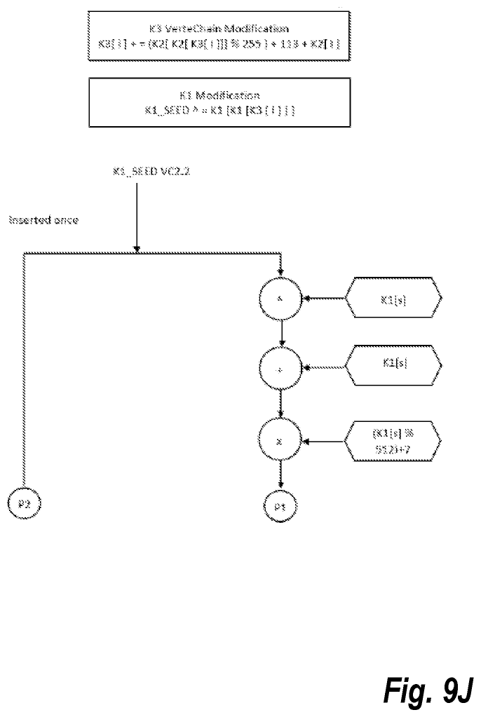

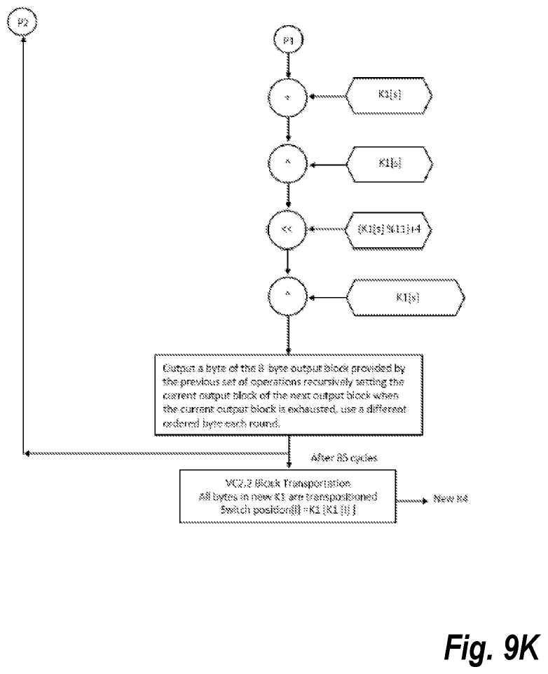

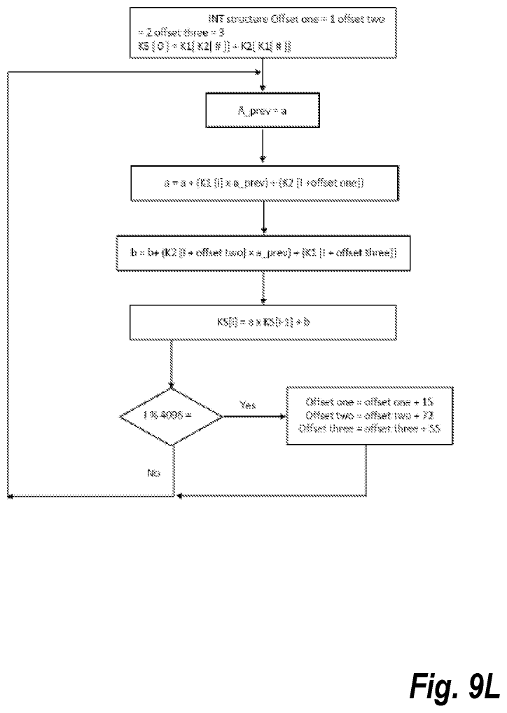

Various techniques may be used for implementing the encryption algorithms used with the techniques described herein. For example, in some embodiments, object keys are created to be used with a 4096-bit secret key block cipher data encryption process and a 2048-bit secret key digital signature process. The object keys are dynamic keys; that is, they change throughout the encryption process. The dynamic object keys are composed of a static initial state that may be created by the user. The keys are modified based on seeding from a random session key object. The object, key modification, is performed for each plaintext data block so that each data block is encrypted using a different key. The initial state of the object key is also used in a block cipher encryption process to encrypt a 512-bit random session key. Data blocks of 64 bytes each are encrypted utilizing a different key, provided by the object key, for each block. The ciphertext (encrypted file) is transmitted into a keyed hashed function that utilizes a 2048-bit object key to produce a unique 2048-bit digital signature that is appended to the ciphertext. The digital signature object key is seeded with the input data. Decryption is accomplished by reversing the encryption process. FIGS. 9A-9L describe this example encryption in more detail.

FIG. 9A provides an overview of the general architecture, which utilizes static keys (K1, K2, K4, and K4) and dynamic keys. As shown in the figure, the dynamic keys and output are sized 2048 and 4096 bits, respectively. For completeness, FIG. 9A also show system components used in the encryption process including Random Access Memory (RAM), a CPU, and flash (non-volatile) memory.

FIG. 9B provides a high-level overview of the encryption process, as it may be implemented in some embodiments. As shown, the process starts with the injection of encryption code. A user types random keys and, based on the user's typing, the initial state of the private key is created. Next, a password is created that is not associated with a private key. The initial object key is appended with a checksum and encrypted with the public key. Then, the user can create a password for a remote user to access the encrypted data. FIGS. 9C-9L describes the encryption process is more detail.

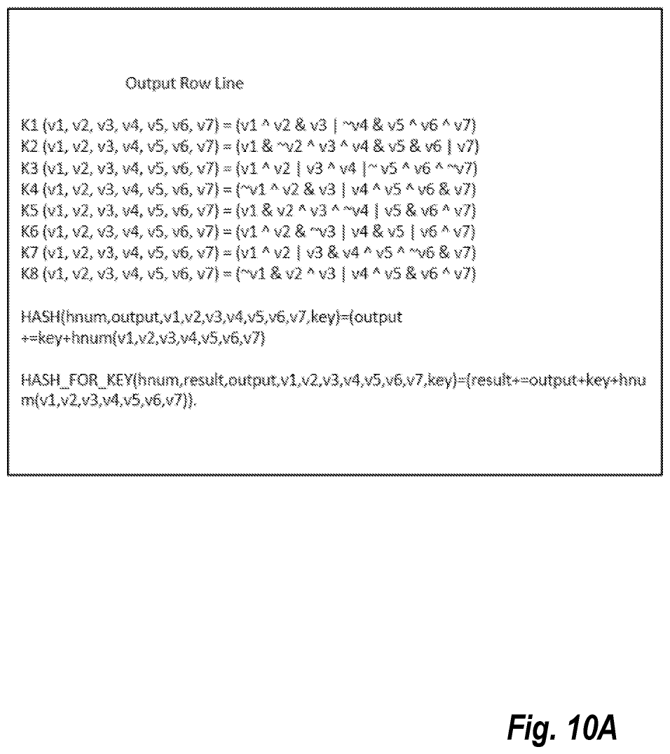

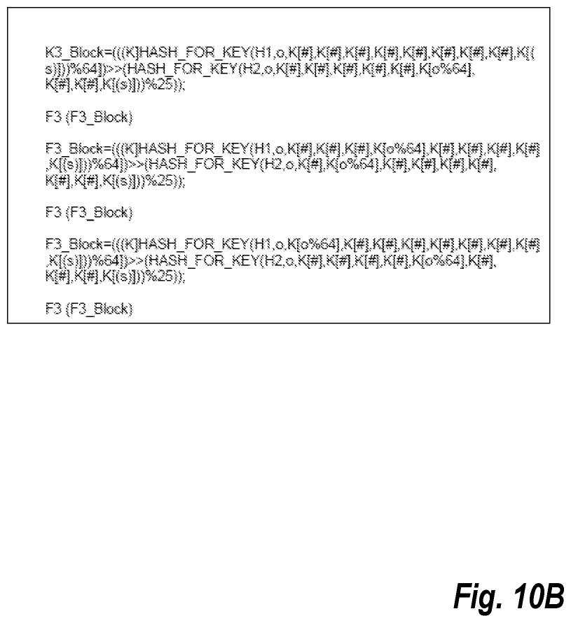

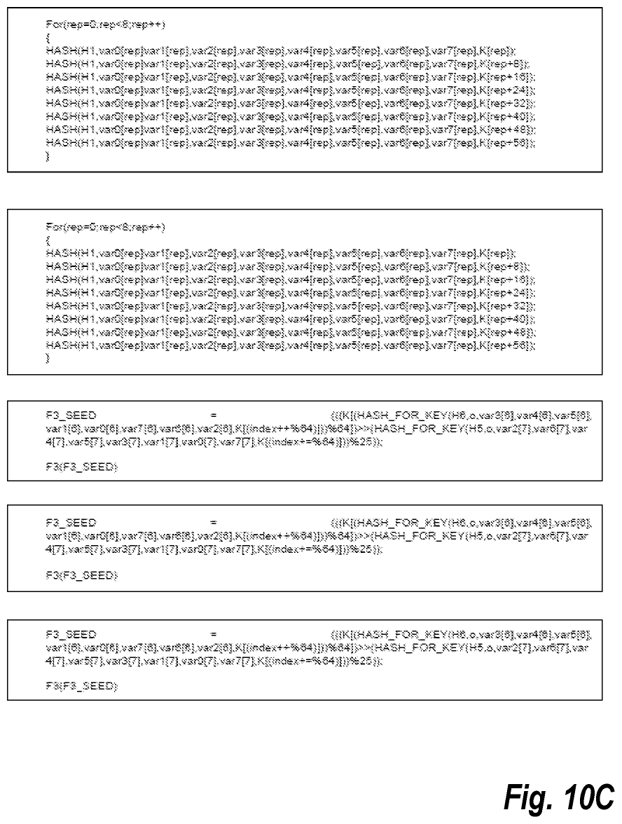

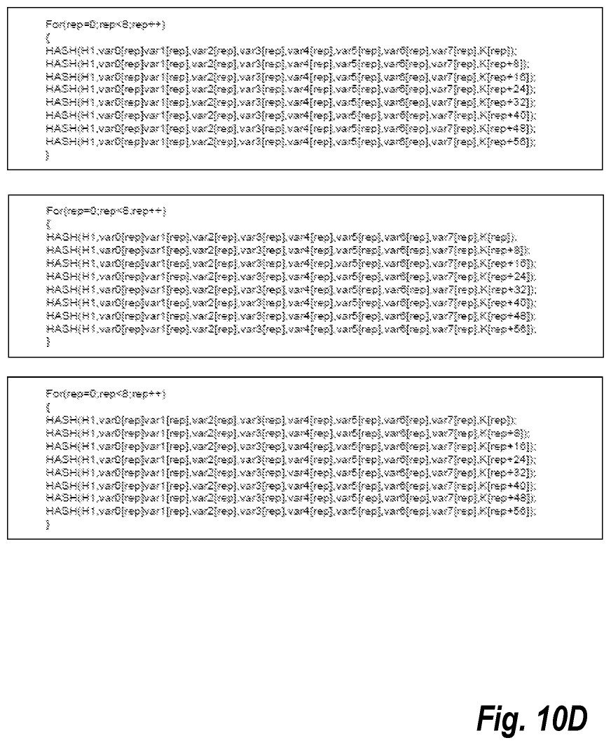

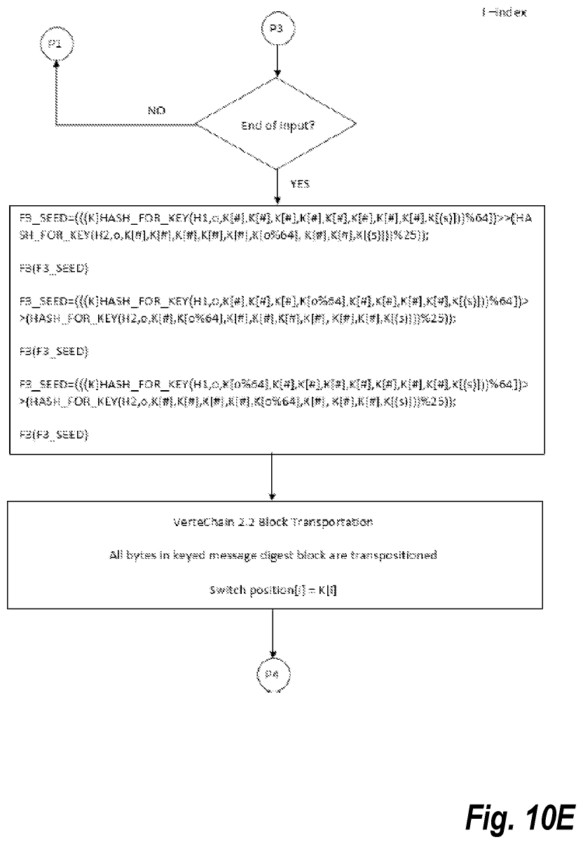

FIGS. 10A and 10B show an example output line resulting from the encryption process. FIGS. 10C and 10D show example code that may be used during seed and key generation, according to some embodiments. Finally, FIG. 10E shows how the seeds are utilized in the encryption process described above.

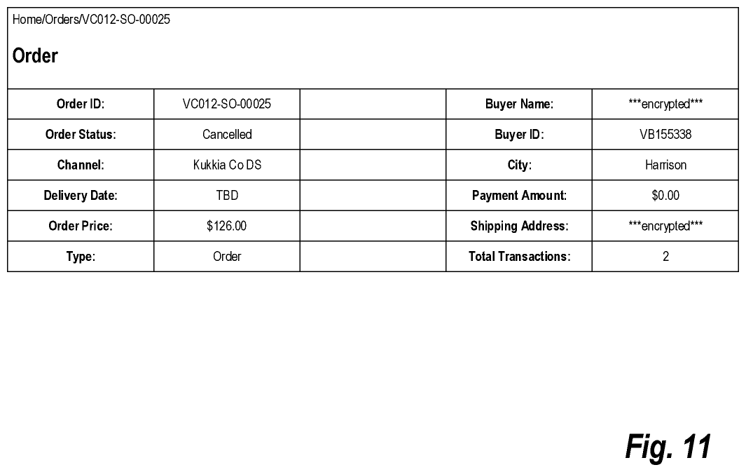

FIG. 11 shows an example use case in the context of supply chain management. This example shows how data can be presented in a publicly viewable graphical user interface (GUI). This data may be shown to users, for example, in a dashboard interface for managing order data. Note that the buyer's name and shipping address are encrypted on the field level; thus these items are not shown in publicly viewable interface.

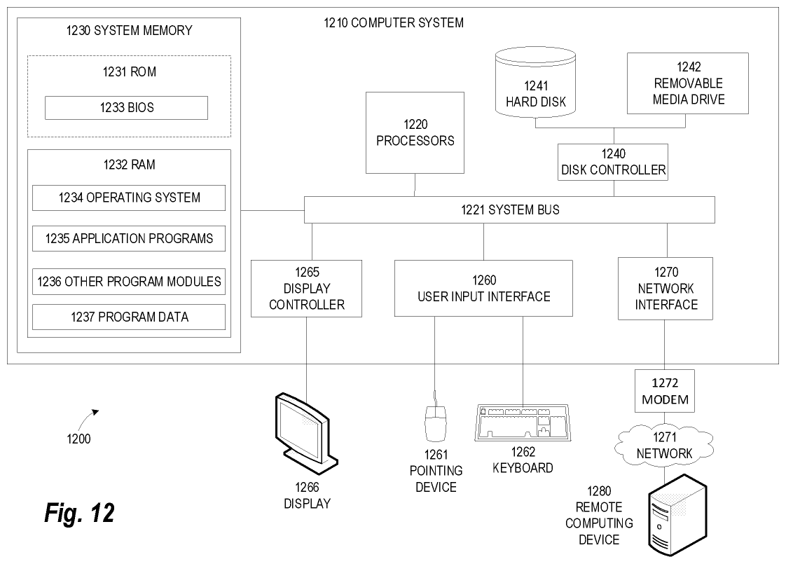

FIG. 12 illustrates an exemplary computing environment 1200 within which embodiments of the invention may be implemented. For example, this computing environment 1200 may be used to execute the various components of the software stack shown in FIG. 1 using one or more executable applications. The computing environment 1200 may include computer system 1210, which is one example of a computing system upon which embodiments of the invention may be implemented. Computers and computing environments, such as computer system 1210 and computing environment 1200, are known to those of skill in the art and thus are described briefly here.

As shown in FIG. 12, the computer system 1210 may include a communication mechanism such as a bus 1221 or other communication mechanism for communicating information within the computer system 1210. The computer system 1210 further includes one or more processors 1220 coupled with the bus 1221 for processing the information. The processors 1220 may include one or more central processing units (CPUs), graphical processing units (GPUs), or any other processor known in the art.

The computer system 1210 also includes a system memory 1230 coupled to the bus 1221 for storing information and instructions to be executed by processors 1220. The system memory 1230 may include computer readable storage media in the form of volatile and/or nonvolatile memory, such as read only memory (ROM) 1231 and/or random access memory (RAM) 1232. The system memory RAM 1232 may include other dynamic storage device(s) (e.g., dynamic RAM, static RAM, and synchronous DRAM). The system memory ROM 1231 may include other static storage device(s) (e.g., programmable ROM, erasable PROM, and electrically erasable PROM). In addition, the system memory 1230 may be used for storing temporary variables or other intermediate information during the execution of instructions by the processors 1220. A basic input/output system 1233 (BIOS) containing the basic routines that help to transfer information between elements within computer system 1210, such as during start-up, may be stored in ROM 1231. RAM 1232 may contain data and/or program modules that are immediately accessible to and/or presently being operated on by the processors 1220. System memory 1230 may additionally include, for example, operating system 1234, application programs 1235, other program modules 1236 and program data 1237.

The computer system 1210 also includes a disk controller 1240 coupled to the bus 1221 to control one or more storage devices for storing information and instructions, such as a hard disk 1241 and a removable media drive 1242 (e.g., floppy disk drive, compact disc drive, tape drive, and/or solid state drive). The storage devices may be added to the computer system 1210 using an appropriate device interface (e.g., a small computer system interface (SCSI), integrated device electronics (IDE), Universal Serial Bus (USB), or FireWire).

The computer system 1210 may also include a display controller 1265 coupled to the bus 1221 to control a display 1266, such as a cathode ray tube (CRT) or liquid crystal display (LCD), for displaying information to a computer user. The computer system includes an input interface 1260 and one or more input devices, such as a keyboard 1262 and a pointing device 1261, for interacting with a computer user and providing information to the processor 1220. The pointing device 1261, for example, may be a mouse, a trackball, or a pointing stick for communicating direction information and command selections to the processor 1220 and for controlling cursor movement on the display 1266. The display 1266 may provide a touch screen interface which allows input to supplement or replace the communication of direction information and command selections by the pointing device 1261.

The computer system 1210 may perform a portion or all of the processing steps of embodiments of the invention in response to the processors 1220 executing one or more sequences of one or more instructions contained in a memory, such as the system memory 1230. Such instructions may be read into the system memory 1230 from another computer readable medium, such as a hard disk 1241 or a removable media drive 1242. The hard disk 1241 may contain one or more data stores and data files used by embodiments of the present invention. Data store contents and data files may be encrypted to improve security. The processors 1220 may also be employed in a multi-processing arrangement to execute the one or more sequences of instructions contained in system memory 1230. In alternative embodiments, hard-wired circuitry may be used in place of or in combination with software instructions. Thus, embodiments are not limited to any specific combination of hardware circuitry and software.

As stated above, the computer system 1210 may include at least one computer readable medium or memory for holding instructions programmed according to embodiments of the invention and for containing data structures, tables, records, or other data described herein. The term “computer readable medium” as used herein refers to any medium that participates in providing instructions to the processor 1220 for execution. A computer readable medium may take many forms including, but not limited to, non-volatile media, volatile media, and transmission media. Non-limiting examples of non-volatile media include optical disks, solid state drives, magnetic disks, and magneto-optical disks, such as a hard disk 1241 or removable media drive 1242. Non-limiting examples of volatile media include dynamic memory, such as system memory 1230. Non-limiting examples of transmission media include coaxial cables, copper wire, and fiber optics, including the wires that make up the bus 1221. Transmission media may also take the form of acoustic or light waves, such as those generated during radio wave and infrared data communications.

The computing environment 1200 may further include the computer system 1210 operating in a networked environment using logical connections to one or more remote computers, such as remote computer 1280. Remote computer 1280 may be a personal computer (laptop or desktop), a mobile device, a server, a router, a network PC, a peer device or other common network node, and typically includes many or all of the elements described above relative to computer system 1210. When used in a networking environment, computer system 1210 may include modem 1272 for establishing communications over a network 1271, such as the Internet. Modem 1272 may be connected to bus 1221 via user network interface 1270, or via another appropriate mechanism.

Network 1271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1210 and other computers (e.g., remote computer 1280). The network 1271 may be wired, wireless, or a combination thereof. Wired connections may be implemented using Ethernet, Universal Serial Bus (USB), RJ-11, or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 1271.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes, and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.

1. A non-volatile storage containing a multi-layer software stack for supporting blockchain transactions comprising:
a wrapper layer providing blockchain nodes with access to transaction data stored on the blockchain, wherein the wrapper layer comprises:
a public application programming interface (API) providing one or more functions for accessing public transaction data stored on the blockchain;
a private API providing one or more functions for accessing private transaction data stored on the blockchain;
an entities logic layer comprising:
an encryption component providing one or more encryption algorithms for encrypting and decrypting the private transaction data,
a dynamic structure layer comprising:
a field-level encryption component providing one or more additional encryption algorithms for encrypting and decrypting individual fields of the transaction data,
a blockchain layer comprising:
one or more blocks storing the transaction data in the blockchain.

2. The multi-layer software stack of claim 1, wherein the wrapper layer further comprises:
a memory pool for buffering the transactions prior to execution at the blockchain layer.

3. The multi-layer software stack of claim 1, wherein the wrapper layer further comprises:
a network hub component managing one or more communication tasks between nodes of the blockchain.

4. The multi-layer software stack of claim 1, wherein the entities logic layer further comprises:
a serialization component for encoding the transaction data in a predetermined format, and
a deserialization component for decoding the transaction data in the predetermined format.

5. The multi-layer software stack of claim 4, wherein the predetermined format is JSON.

6. The multi-layer software stack of claim 1, wherein the entities logic layer further comprises:
a compression component providing one or more compression algorithms for compressing and decompressing the transaction data.

7. The multi-layer software stack of claim 1, wherein the dynamic structure layer further comprises:
a Dynamic Permission Layer (DPL) component managing permissions associated with the transaction data.

8. The multi-layer software stack of claim 1, wherein the dynamic structure layer further comprises:
a rules and contracts component managing rules and contracts applied to the transaction data.

9. A method for encrypting an input blockchain data structure that contains a plurality of data blocks comprising steps of:
obtaining a first secret key having a static initial state and a random session key that is created for each blockchain being encrypted;
creating a dynamic object key that is a function of the second secret key and the random session key;
for each data block, changing the dynamic object key based on the random session key and encrypting the data block using the dynamic object key to create an encrypted file of the blockchain that contains ciphertext of each data block; and
adding a hash of the data blocks to the encrypted file using a keyed hash function that utilizes a second secret key seeded by data blocks of the input blockchain to create a signature.

10. The method of claim 9, wherein the first secret key is at least 4096 bits and the second secret key is 2048 bits, resulting in a 2048 bit signature.

11. The method of claim 9 further comprising transmitting the encrypted file to a blockchain network.

12. A method for compressing a blockchain, the blockchain having a plurality of data strings, for transmission over a blockchain network comprising steps of:
for each data string, replacing one of more input data characters with new characters to create a current data string;
matching the current data string to the contents of a longest previous data string;
placing a code corresponding to the longest previous data string into a compressed data stream;
extending current data string by a plurality of symbols; and
placing a string extension length indicative of the plurality of symbols into the compressed data stream.

13. The method of claim 12 further comprising encrypting and transmitting the compressed data stream to the blockchain network.
